(19) United States
(12) Patent Application Publication
(10) Pub. No.: US 2014/0254160 A1
(43) Pub. Date: Sep. 11, 2014

(54) DIFFUSER CAPABLE OF ENHANCING INTENSITY OF OUTPUT LIGHT AND OPTICAL SYSTEM USING THE SAME

(71) Applicant: LUXO-LED TAIWAN LIMITED, Taipei City (TW)

(72) Inventor: Percy VANLUCHENE, Taipei City (TW)

(73) Assignee: LUXO-LED TAIWAN LIMITED, Taipei City (TW)

(21) Appl. No.: 14/203,311

(22) Filed: Mar. 10, 2014

Related U.S. Application Data
(60) Provisional application No. 61/776,583, filed on Mar. 11, 2013.

(51) Int. Cl. F21V 5/00; G02B 5/02

(52) U.S. Cl. CPC F21V 5/004; G02B 5/0226
USPC 362/268; 362/355; 362/311.01

(57) ABSTRACT

A diffuser and an optical system is provided in the present disclosure. The diffuser is configured to enhance the intensity of a light generated from a light source. The diffuser includes a transparent substrate, a transparent metalized layer, a bonding layer, and a plurality of light-penetrating microsphere balls. The transparent substrate has a first surface and a second surface. The transparent metalized layer is disposed on the first surface of the transparent substrate. The bonding layer is disposed on the transparent metalized layer. The plurality of light-penetrating microsphere balls are disposed on the bonding layer. The first surface is opposite to the second surface, and the light enters the diffuser from the second surface of the transparent substrate.

### CROSS REFERENCE TO RELATED APPLICATION

The application claims priority based on U.S. provisional application Ser. No. 61/776,583, filed 2013 Mar. 11, entitled DIFFUSER CAPABLE OF ENHANCING INTENSITY OF OUTPUT LIGHT AND OPTICAL SYSTEM USING THE SAME, which is hereby incorporated by reference in its entirely.

### BACKGROUND

1. Technical Field

The present disclosure relates to a diffuser and an optical system having the diffuser, and more particularly, to a diffuser capable of enhancing the intensity of an output light and an optical system having the same diffuser.

2. Related Art

Diffusers when incorporated in an optical system are generally designed for equally spreading the light to another component of the optical system. Conventional diffusers are often subject to loss of intensity because of characteristics of the substrate of the diffusers. Therefore, despite the light outputted by the diffusers may still be equally spread to another component in the same optical system the attenuated light intensity could lead to undesired consequences without being further enhanced.

### SUMMARY

A diffuser and an optical system is provided in the present disclosure. The diffuser is configured to enhance the intensity of a light generated from a light source. The diffuser includes a transparent substrate, a transparent metalized layer, a bonding layer, and a plurality of light-penetrating microsphere balls. The transparent substrate has a first surface and a second surface. The transparent metalized layer is disposed on the first surface of the transparent substrate. The bonding layer is disposed on the transparent metalized layer. The plurality of light-penetrating microsphere balls are disposed on the bonding layer. The first surface is opposite to the second surface, and the light enters the diffuser from the second surface of the transparent substrate.

The optical system includes a diffuser, a light source, a transparent medium between the diffuser and the light source. The diffuser is configured to enhance the intensity of a light emitted from the light source. The diffuser includes a transparent substrate, a transparent metalized layer, a bonding layer, and a plurality of light-penetrating microsphere balls. The transparent substrate has a first surface and a second surface. The transparent metalized layer is disposed on the first surface of the transparent substrate. The bonding layer is disposed on the transparent metalized layer. The plurality of light-penetrating microsphere balls are disposed on the bonding layer. The first surface is opposite to the second surface, the light emitted from the light source penetrates the transparent medium before entering the diffuser from the second surface of the first transparent substrate.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic diagram of a diffuser according to one embodiment of the present disclosure;

FIG. 2 is a schematic diagram of an optical system according to one embodiment of the present disclosure;

FIG. 3 is a schematic diagram of another optical system according to one embodiment of the present disclosure;

FIG. 4 illustrates another optical system according to one embodiment of the present disclosure; and

FIG. 5 shows a micro lens assembly according to one embodiment of the present disclosure.

### DETAILED DESCRIPTION

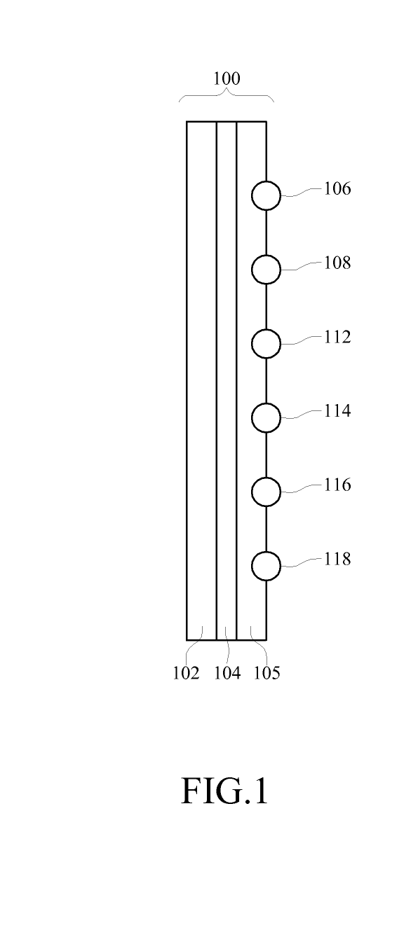

Please refer to FIG. 1 of a schematic diagram of a diffuser 100 according to one embodiment of the present disclosure. The diffuser 100 may include a transparent substrate 102, a transparent metalized layer 104 on the transparent substrate 102, a bonding layer 105 applied on the transparent metalized layer 104, and a plurality of light-penetrating microsphere balls 106, 108, 112, 114, 116, and 118. The bonding layer 105 may be used to position the light-penetrating microsphere balls 106-118. At the same time, the bonding layer 105 may partially submerge the light-penetrating microsphere balls 106-118 after the placement of the light-penetrating microsphere balls 106-118.

The bonding layer 105 may be formed substantially at the same time with the light-penetrating microsphere balls 106-118. In another implementation, the bonding layer 105 may be applied upon the transparent metalized layer first, before the light-penetrating microsphere balls 106-118 are placed. The light-penetrating microsphere balls 106-118 may vary from each other in size. In another implementation, the light-penetrating microsphere balls 106-118 may be in the same size. The size of the light-penetrating microsphere balls 106-118 may range from 20 micrometers to 100 micrometers, depending on the desired intensity of an output light of the diffuser 100.

The light-penetrating microsphere balls 106-118 may be equally distributed in the area defined by the bonding layer 105. In another implementation, however, the light-penetrating microsphere balls 106-118 may end up being randomly placed in the area defined by the bonding layer 105 because of the process used for the placement of the light-penetrating microsphere balls 106-118.

The bonding layer 105 may be applied to the transparent metalized layer 104 by ultra-violet cured coating. Plus, the thickness of the bonding layer may be between 20 micrometers and 30 micrometers.

It is worth noting that in one implementation the light-penetrating microsphere balls 106-118 are TiO2—BaO—SiO2 glass. And in another implementation the light-penetrating microsphere balls are TiO2—BaO—ZnO glass.

The transparent substrate 102 may be a PET substrate or in form of other transparent materials, when the transparent metalized layer 104 may be applied upon the transparent substrate 102 by the process of sputtering. The transparent metalized layer 104 may be the end result of the sputtering of silver or aluminum though other materials may be considered when the present disclosure is implemented.

The diffuser 100 overall may be a structure associated with the refractive index ranging from 1.93 to 2.2, so that the output light of the diffuser could be properly scattered for compensating potential intensity loss associated with the transparent substrate 102. It is worth noting that the output light throughout the present disclosure may refer to the light outputted from the diffuser 100.

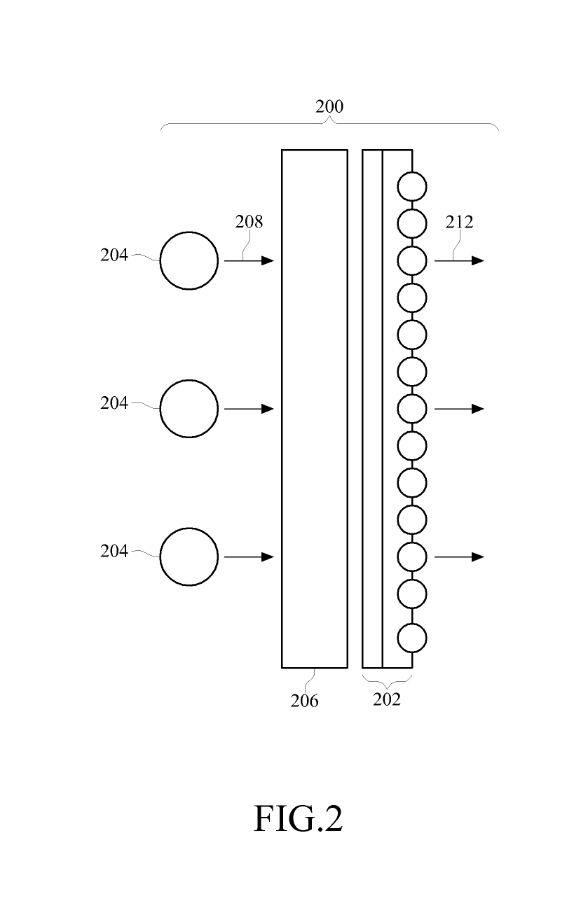

Please refer to FIG. 2 illustrating an optical system 200 according to one embodiment of the present disclosure. The optical system 200 may include a diffuser 202, a light source 204, and a transparent medium 206 between the light source 204 and the diffuser 202. In one implementation, the diffuser 202 may be the same as the diffuser 100 shown in FIG. 1.

In one implementation, the transparent medium 206 is made of resin, while in another implementation the transparent medium 206 is a glass. Input lights 208 emitted from the light source 204 therefore may penetrate the transparent medium 206 before being received by the diffuser 202, which may cause output lights 212 with enhanced light intensity to be generated. The intensity of the output light 212 may be 1.3-1.5 times of the intensity of the input light 208.

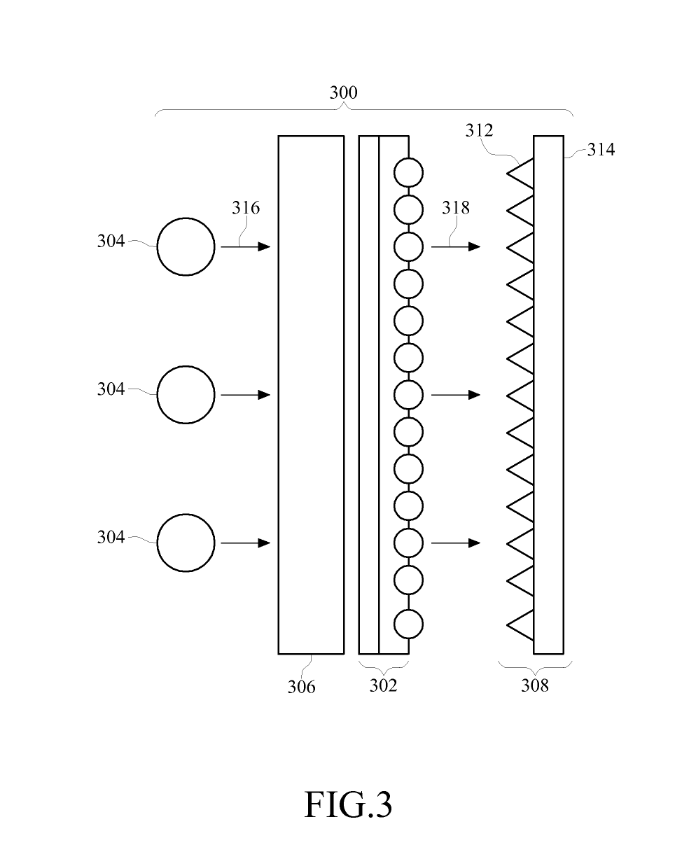

Please refer to FIG. 3 illustrating another optical system 300 according to one embodiment of the present disclosure. The optical system 300 may include a diffuser 302, a light source 304, a transparent medium 306, and a micro lens array assembly 308. The micro lens array assembly 308 may further include a micro lens array 312 and a transparent substrate 314 on which the micro lens array 312 is placed.

Both the diffuser 302 and the transparent medium 306 may be similar to their counterparts in FIG. 2, which are the diffuser 202 and the transparent medium 206, respectively. In another implementation, the diffusers 202 and 302 may also include an anti-reflective layer (not shown) placed between the substrates and the light-penetrating microsphere balls.

The light source 304 may emit input lights 316 through the transparent medium 306 to the diffuser 302, which may therefore generate output lights 318 with enhanced intensity. The output light 318 may be further received by the micro lens array 312, which may be utilized to guide the received output light 318 to the desired direction. It is worth noting that parameters of the micro lens array 312 such as the shape, the height, and even the pitch width of micro lens in the micro lens array 312 may dictate the guiding direction of the received output light 318.

The micro lens array 312 may be arranged corresponding to the position of the light-penetrating microsphere balls of the diffuser 302. Despite the light-penetrating microsphere balls of the diffuser 302 may be randomly placed as previously mentioned, the micro lens array 312 may be uniformly distributed in the surface area of the transparent substrate 314. It is worth noting that the arrangement of the micro lens of the micro lens array at least has to correspond to where the light-penetrating microsphere balls of the diffuser 302 are located.

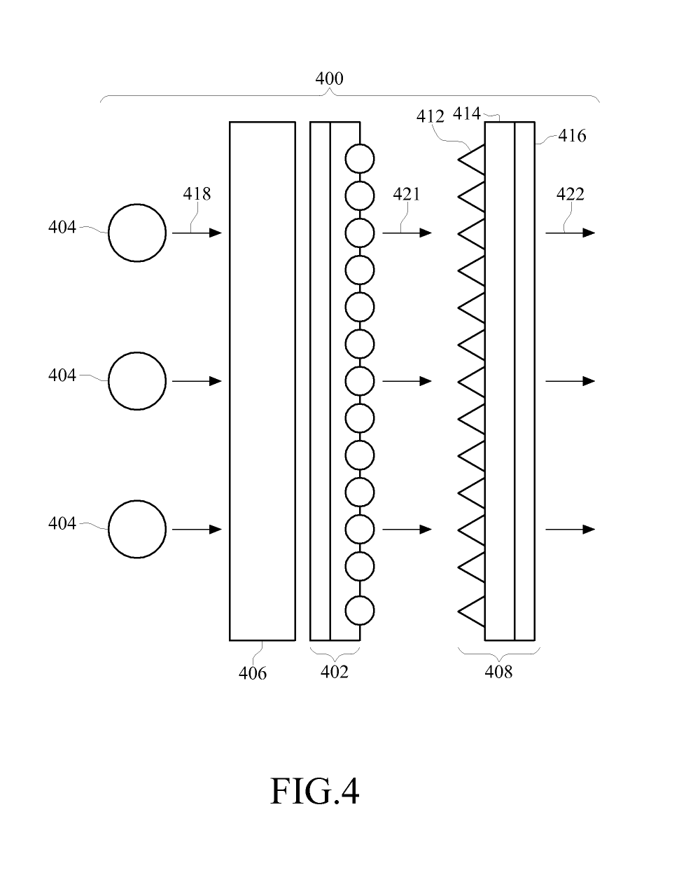

FIG. 4, meanwhile, illustrates another optical system 400 according to one embodiment of the present disclosure. The optical system 400 may include a diffuser 402, a light source 404, a transparent medium 406 between the diffuser 402 and the light source 404, and a micro lens assembly 408. The micro lens assembly 408 may further include at least one first micro lens array 412, a transparent substrate 414 having a first surface on which the first micro lens 412 is placed, and a second micro lens array 416 placed on a second surface of the transparent substrate 414. The first surface of the transparent substrate 414 may be opposite to the second surface of the transparent substrate 414.

With the above arrangement, input lights 418 emitted from the light source 404 may penetrate the transparent medium 406 before being received by the diffuser 402. The diffuser 402 upon the receipt of the input lights 418 may cause first output lights 421 to be emitted to the micro lens assembly 408. The micro lens assembly 408 may rely on both the first micro lens array 412 and the second micro lens array 416 to direct second lights 422 along the desired direction. In other words, both the first micro lens array 412 and the second micro lens array 416 may be capable of directing the lights they receive. For example, the first micro lens array 412 may not divert the first output lights 421 (i.e., without affecting the guiding direction of the first output lights 421) when the second micro lens array may cause the second output lights 422 to be guided along the direction vertical to the direction along with the first output lights 421 travel. Plus, the first output lights 421 emitted from the diffuser 402 may be the enhanced version of the input lights 418 from the intensity perspective. And the intensity of the second output lights 422 may not be different from the intensity of the first output lights 421.

That the second output lights 422 may be different from the first output lights 421 direction-wise increases the amount of the light to the desired location and has several benefits such as improving the brightness and enhancing the anti-glare effect associated with the optical system 400.

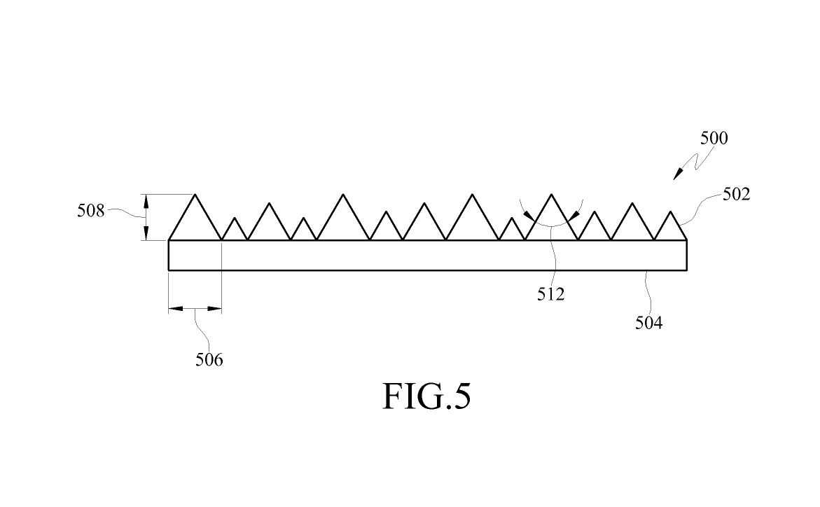

Please refer to FIG. 5 illustrating a micro lens assembly 500 according to one embodiment of the present disclosure. The micro lens assembly 500 may include a micro lens array 502 and a transparent substrate 504 on which the micro lens array 502 is placed. The micro lens array 502 may be made of acrylic resin and in form of such acrylic layer coated on the transparent substrate 504. In one implementation, the transparent substrate may be a polyester PET substrate.

The parameters of the micro lens array 502 may include width (pitch) 506, height 508, and an angle 512 of the micro lens. Each micro lens of the micro lens array may be different from others in terms of width/pitch 506, height 508, and angle 512. In one implementation, the width 506 of the micro lens may be 50 micrometers, while the angle of the micro lens may range between 75 to 90 degrees.

The foregoing description of the exemplary embodiments of the present disclosure has been presented only for the purposes of illustration and description and is not intended to be exhaustive or to limit the invention to the precise forms disclosed. Many modifications and variations are possible in light of the above teaching.

The embodiments were chosen and described in order to explain the principles of the present disclosure and their practical application so as to activate others skilled in the art to utilize the present disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A diffuser for enhancing the intensity of a light emitted from a light source, comprising:
a transparent substrate having a first surface and a second surface;
a transparent metalized layer disposed on the first surface of the transparent substrate;
a bonding layer disposed on the transparent metalized layer; and
a plurality of light-penetrating microsphere balls disposed on the bonding layer;
wherein the first surface is opposite to the second surface, and the light enters the diffuser from the second surface of the transparent substrate.

2. The diffuser according to claim 1, wherein the bonding layer is configured to position the light-penetrating microsphere balls, and the bonding layer partially submerges the light-penetrating microsphere balls.

3. The diffuser according to claim 2, wherein the light-penetrating microsphere balls are equally distributed in the area defined by the bonding layer.

4. The diffuser according to claim 2, wherein the light-penetrating microsphere balls are randomly placed in the area defined by the bonding layer.

5. An optical system, comprising:
a light source for emitting a light;
a diffuser for enhancing the intensity of the light emitted from the light source, comprising:
a first transparent substrate having a first surface and a second surface;
a transparent metalized layer disposed on the first surface of the first transparent substrate;
a bonding layer disposed on the transparent metalized layer; and
a plurality of light-penetrating microsphere balls disposed on the bonding layer; and
a transparent medium disposed between the light source and the diffuser;
wherein the first surface is opposite to the second surface, and the light emitted from the light source penetrates the transparent medium before entering the diffuser from the second surface of the first transparent substrate.

6. The optical system according to claim 5, wherein the bonding layer is configured to position the light-penetrating microsphere balls, and the bonding layer partially submerges the light-penetrating microsphere balls.

7. The optical system according to claim 6, wherein the light-penetrating microsphere balls are equally distributed in the area defined by the bonding layer.

8. The optical system according to claim 6, wherein the light-penetrating microsphere balls are randomly placed in the area defined by the bonding layer.

9. The optical system according to claim 6, further comprising:
a micro lens array assembly, comprising:
a second transparent substrate having a third surface and a fourth surface; and
a micro lens array disposed on the third surface of the second transparent substrate;
wherein the third surface is opposite to the fourth surface, and the light outputted from the diffuser is received by the micro lens array.

10. The optical system according to claim 9, wherein the micro lens array is configured to guide the received light to a desired direction.

11. The optical system according to claim 9, wherein the micro lens array assembly further comprises a second micro lens array placed on the fourth surface of the second transparent substrate.
